(19) United States
(12) Patent Application Publication
(10) Pub. No.: US 2004/0137120 A1
(43) Pub. Date: Jul. 15, 2004

(54) Method of preparing a chunky animal foodstuff or food

(76) Inventor: Johannes P Schlebusch, Thedinghausen (DE)

Correspondence Address: FULBRIGHT & JAWORSKI, LLP, 1301 MCKINNEY, SUITE 5100, HOUSTON, TX, 77010-3095, US

(21) Appl. No.: 10/473,554

(22) PCT Filed: Apr. 9, 2002
(86) PCT No.: PCT/EP02/03939

(30) Foreign Application Priority Data
Apr. 12, 2001 (DE) 101 18 334.8

(51) Int. Cl. A23K 1/00

(52) U.S. Cl. 426/331

(57) ABSTRACT

A method of preparing a chunky animal foodstuff or food from an emulsion, said emulsion being introduced into a viscous carrier matrix, said emulsion being subjected to conditions which lead it to solidify, said carrier matrix being subjected to conditions which lead it to liquefy, and the solidified emulsion being separated from the liquefied carrier matrix.

### CROSS-REFERENCE TO RELATED APPLICATIONS

This application is a national stage filing of PCT/EP02/03939 filed Apr. 9, 2002, claiming priority to DE 101 18334.8 filed Apr. 12, 2001.

### TECHNICAL FIELD

The invention relates to a method of preparing a chunky animal foodstuff or food, and a product producible by said method.

### BACKGROUND OF THE INVENTION

In the production of animal foodstuffs and food, use is frequently made of emulsions, which may be of vegetable and/or animal origin. In particular in the field of producing animal foodstuffs for pets, greater use is being made of these. At the same time, there is a need to use as large a proportion as possible of meat as raw material, optionally in combination with vegetable proteins, since these are important sources of proteins, minerals, trace elements, fats and vitamins.

In order to solidify the emulsions of a particular composition in conventional processes, they are heated. At temperatures of more than 100° C., both the animal and the vegetable proteins in the emulsion coagulate and denature very rapidly. The hot emulsion is subsequently pumped into a process tube, where it remains at super-atmospheric pressure until the proteins have coagulated completely. The description of one such process is known from the patent EP 0 265 740 A2. In that process, the meaty raw materials in particular lose a great amount of their texture, which the processors subsequently try to compensate for in the known process by means of a process step involving considerable energy and effort.

Apart from solidifying the emulsion in a process tube with heat applied, there are processes which use gas stoves, steam towers or steam tunnels in order to prepare the chunky animal foodstuff and food.

Since either conveyor belts or process tubes are used to solidify the animal foodstuff and food in the above-mentioned processes, the surface texture of the animal foodstuff and food is not very variable. The product is only given its final shape in the subsequent cutting process, where the variability of the product shape is heavily restricted for economic reasons.

In another process, water is used as a carrier material, which does not have any shaping effect, because of its low viscosity. For this reason, neither the texture nor the shape of the product produced can be variably controlled.

The texture and shape of a chunky animal foodstuff or piece of food produced from a solidifying emulsion plays a major role in the product's acceptance by human beings and animals. Another factor is that, by changing the surface texture and redesigning the shape, it is possible to enlarge the surface of the product considerably and thus to improve the capacity of the final product to absorb additives added to the animal foodstuffs or food (such as sauces).

The problem on which the invention is based is therefore to overcome the disadvantages of the state of the art and to produce an animal foodstuff or food with greater variability in terms of its shape.

This problem is solved in accordance with the invention in that the emulsion is introduced into a viscous carrier matrix, the emulsion is subjected to conditions which lead it to solidify, the carrier matrix is subjected to conditions which lead it to liquefy, and the solidified emulsion is separated from the liquefied carrier matrix.

### BRIEF SUMMARY OF THE INVENTION

In a preferred embodiment, the carrier matrix is a viscous fatty mass.

The emulsion is preferably a meat, vegetable protein or alginate emulsion.

The method of the invention provides for the emulsion to solidify while energy is applied.

According to an alternative method, the emulsion solidifies in the course of time.

In a preferred embodiment, the energy applied consists of microwave energy.

In an alternative embodiment, the energy applied is thermal energy.

It is envisaged that the method be carried out in a tube system.

The invention further envisages that, after the animal foodstuff or food has been separated, the carrier matrix can be cooled and re-used in the process.

The invention further relates to a chunky animal foodstuff or food which can be prepared by the method according to the invention.

The product which can be prepared according to the method of the invention possesses a novel surface texture and shape because of the novel method by which the pieces of animal foodstuff or food solidify in free flow in a matrix which is initially viscous, then liquefied.

### BRIEF DESCRIPTION OF THE DRAWINGS

In order to demonstrate the invention more clearly, a particularly preferred embodiment of the invention will now be described in more detail, by means of which an improved product can be prepared in an optimum manner. This method will be explained in more detail by reference to the attached drawing, which shows a schematic view of the device.

FIG. 1 shows a schematic view of the device according to the invention.

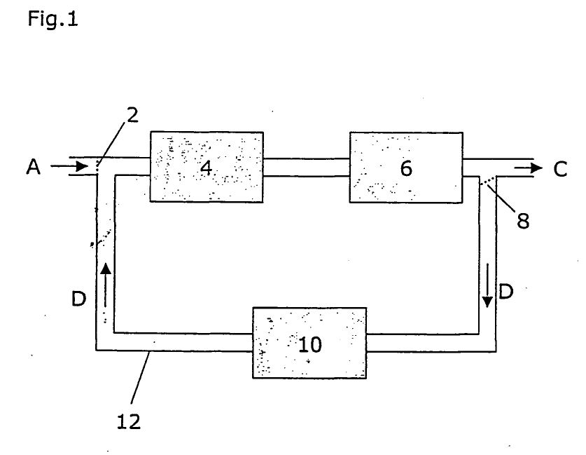

### DETAILED DESCRIPTION OF THE INVENTION

An animal foodstuff or food emulsion A is pumped through a forming nozzle 2 into a tube system 12 in which a matrix D is circulating. The tube system 12 passes through a microwave unit 4 in which, when microwaves are applied, the emulsion solidifies and the matrix liquefies. In the cutting device 6 downstream, the animal foodstuff or food is cut such that the chunky foodstuff C results, which is separated from the matrix. The liquid matrix D flows through a sieve 8 into a cooling system 10. The matrix D, which is viscous after cooling, is re-used in the circuit.

In a preferred embodiment of the invention, the microwave unit 4 can take the form of a heating unit which liquefies the matrix by heating after an alginate emulsion, for example, has solidified in the course of time.

The way in which the device according to the invention works will now be described.

A conventional food or animal foodstuff emulsion A is injected via a forming nozzle 2 into a viscous carrier matrix D, preferably consisting of fat. The fat can, for example, be suet, oil or any other fat. The emulsion A remains in the shape given by the injection nozzle 2 and flow dynamics, since it is supported by the viscous matrix D. In the tube system 12, the emulsion A is passed, in the matrix D, through the microwave unit 4. The microwaves heat the water contained in the protein of emulsion A, which causes emulsion A to coagulate and solidify. Because of the heat generated in emulsion A, matrix D is likewise heated up in the course of the process, which causes it to liquefy. At this moment, the carrier properties of the matrix D are no longer needed, since the emulsion A has already solidified in the desired shape with the chosen surface texture. After the chunky animal foodstuff or food C has been cut in a cutting device 6, the matrix D is separated from it for re-use, via a sieve 8. In the circuit, the matrix D is cooled down so powerfully in a cooling system 10 that it can be used again as a carrier substance to help emulsion A retain its shape.

In the method of the invention, the fat is primarily used as a carrier substance and is subsequently separated from the chunky animal foodstuff or food. The surface of the chunky animal foodstuff or food is defined by the forming injection nozzle and the flow dynamics. As a result, it is possible to produce shapes, such as hollow shapes, and to provide new surfaces, such as flat, striped or corrugated.

The method of the invention and a product producible by said method will now be explained in more detail with reference to two examples:

### Example 1

In order to prepare a meat emulsion, 33% turkey breast meat, 60% pigs' liver, 5% powdered blood plasma and 2% minerals and vitamins are stirred in a cutter until they are smooth and well emulsified. This viscous meat emulsion is introduced via two concentric tubular nozzles into a stream of hardened palm oil conditioned to 35 to 40° C. The internal diameter of the inner tubular nozzle, the walls of which are 1 mm thick, is 4 mm; that of the outer tubular nozzle is 10 mm. The palm oil matrix, which has been cooled down to 35 to 40° C. in a heat exchanger, is pumped through the inner tube, and the meat emulsion through the outer tube. The meat emulsion thus formed is pumped into a tube with an internal diameter of 20 mm into a circulating stream of a fat matrix consisting of hardened palm oil. In said tube, the three flows consisting of the fat matrix on the inside, meat emulsion, and fat matrix on the outside, are passed at a suitably adjusted speed through a microwave heating unit. In this process step, the proteins in the meat emulsion solidify, so that the hollow body of meat thus obtained can be cut into lengths of 35 mm after exiting the flow tube. The fat which has been melted out of the meat via the residual heat is separated by means of a sieve and re-circulated having been conditioned back to 35 to 40° C. by a cooler.

### Example 2

A meat emulsion prepared in accordance with Example 1 is pumped via a tubular nozzle with an internal diameter of 8 mm into a flow tube with an internal diameter of 20 mm. In the flow tube, there is a matrix of hardened palm oil, which has been conditioned to 35 to 40° C. The flow speed of the meat emulsion and the fat matrix are adjusted appropriately. The flow tube is directed through a microwave heating unit, with the proteins in the meat emulsion solidifying while passing through, and after exiting the flow tube, drop-shaped pieces of meat approx. 25 mm in length are obtained. The fat melted via the residual heat from the meat is separated via a sieve and conditioned back to 35 to 40° C. using a cooler, and then re-circulated.

The features of the invention disclosed in the above description, in the claims and the drawing may be essential either individually or in any combination in order to carry out the invention in its various embodiments.

What is claimed is:

1. A method of preparing a chunky animal foodstuff or food from an emulsion, characterised in that said emulsion is introduced into a viscous carrier matrix, said emulsion is subjected to conditions which lead it to solidify, said carrier matrix is subjected to conditions which lead it to liquefy, and the solidified emulsion is separated from the liquefied carrier matrix.

2. A method as claimed in claim 1, characterised in that the carrier matrix is a viscous fatty mass.

3. A method as claimed in claim 1 or 2, characterised in that the emulsion is a meat, vegetable protein or alginate emulsion.

4. A method as claimed in any of claims 1 to 3, characterised in that the emulsion solidifies while energy is applied.

5. A method as claimed in any of claims 1 to 3, characterised in that the emulsion solidifies in the course of time.

6. A method as claimed in any of the preceding claims, characterised in that the energy applied is microwave energy.

7. A method as claimed in any of the preceding claims, characterised in that the energy applied is thermal energy.

8. A method as claimed in any of the preceding claims, characterised in that the method is carried out in a tube system.

9. A method as claimed in any of the preceding claims, characterised in that, after the animal foodstuff or food has been separated, the carrier matrix is cooled and re-used in the process.

10. A chunky animal foodstuff or food producible by a method according to any of the preceding claims.
